(19) United States
(12) Patent Application Publication
(10) Pub. No.: US 2015/0302447 A1
(43) Pub. Date: Oct. 22, 2015

(54) SYSTEMS, METHODS AND DEVICES FOR NON-ACQUIRED ACCOUNT PAYMENT AFFINITY DONATION

(71) Applicant: EDATANETWORKS INC., Edmonton (CA)

(72) Inventor: Terrance Patrick TIETZEN, Edmonton (CA)

(21) Appl. No.: 14/646,235

(22) PCT Filed: Nov. 20, 2013
(86) PCT No.: PCT/CA2013/000971

§ 371 Date: May 20, 2015

Related U.S. Application Data
(60) Provisional application No. 61/728,702, filed on Nov. 20, 2012.

(51) Int. Cl. G06Q 30/02; G06Q 20/10

(52) U.S. Cl. CPC G06Q 30/0215; G06Q 30/0224; G06Q 30/0259; G06Q 20/10; G06Q 30/0279

(57) ABSTRACT

A cash payment system incents a customer to transact at a merchant's brick and mortar store in the customer's local community by the merchant's agreement to make an auditable donation to a charity serving the local community, where the charity is selected by the customer. Various merchant business rules limit the merchant's donations over specific calendar periods, which donations can be made directly by the merchant to the charity, or indirectly to the charity by way of a blind donation made by the merchant to a donation disbursement agency acting on the merchant's behalf to satisfy the merchant's commitment to donate.

### FIELD

Embodiments described herein generally relate to an incentive by a merchant having a physical store in a community to encourage a consumer residing in the community to make a purchase in the physical store and to pay for the purchase with a non-acquired account payment method, and more particularly relate to the merchant encouraging the consumer to conduct the transaction and pay by cash, check, or other a non-acquired account payment method incented by the merchant making a donation to an entity to which both the merchant and the consumer have an affinity.

### BACKGROUND

A merchant generally shares a portion of sales revenue for each transaction with the merchant's acquirer who collects funds for the transaction when it has been conducted on an account issued by an issuer to an account holder with whom the merchant conducted the transaction. This portion of revenue is sometimes described in conjunction with an interchange rate assessed to the merchant for the transaction. As such, it may be advantageous for the merchant to accept cash instead of accepting payment by credit or debit account to thereby avoid the required revenue sharing with the merchant's acquirer. Credit and debit account payments may not replace cash payments entirely because some merchants would prefer to accept cash to avoid paying for the interchange rate assessment and some of the merchant's customers may be unbanked or under banked and therefore without an account issued to them upon which their transactions can be conducted. Moreover, the merchant who prefers cash payment may impose a surcharge on a customer who chooses to pay for a transaction on a debit or credit account, thereby passing the interchange rate cost on to the customer. Moreover, passing the interchange rate cost on to the customer is likely when a merchant is selling a small-ticket item in a low currency amount transaction that still carries a relatively high interchange rate assessment, which cost may influence the customer to choose to pay for the small-ticket item in cash instead of paying on a debit or credit account.

Merchants may use techniques to prompt consumers into making a particular purchase. These techniques may be in the form of monetary incentives, relying on the principle that a lower price may result in increased sales. Merchants may employ these techniques, for example, to help clear inventory before a new season's merchandise is released, to ease the release of a new product, to increase sales near the end of the fiscal year, to compete with a competitor over particular products, or to generally spur sales. Monetary incentives may come in the form of a “sale” (i.e., temporary reduction in price at the register), a discount coupon, a mail-in rebate (i.e. a refund of part or the entire purchase price by mail), or a store credit (i.e. credit that can be applied to another store purchase). These incentives may only apply to a particular product and have a time component. For example, a sale may only apply to a particular brand of dishwasher purchased on a particular holiday weekend and a rebate may only be valid for computers purchased within two weeks before the start of classes at a university.

Although consumers are typically incented to make purchases by a form of price reduction, there exists a need for platforms, systems and methods that provide non-monetary reasons to motivate consumers to make purchases with a merchant, for instance where the consumers believes that the merchant is a force for good and thus the consumers are non-monetarily incented to do business with the merchant who they deem worthy of such support. There exists a need for platforms, systems and methods that provide a non-monetary incentive motivate consumers to conduct transactions with the merchant, or at least an alternative.

Another problem for merchants, especially small to mid-sized merchants, may be that an increasing number of transactions are conducted online instead of inside brick and mortar stores. Online transactions conducted with larger merchants can represent a loss in sales to traditional small and medium size merchants whose main business method to attract sales may be a traditional retail, brick and mortar store environment, instead of mail orders, telephone orders, and/or electronic commerce (e-commerce) transactions. The loss of the in-store purchase may be a lost opportunity for the local merchant and local customer to get to know each other, personally, and a lost opportunity for the local customer to become a live advertisement for the merchant's retail store and its wares. Online sales also prohibit the traditional brick and mortar merchant from an opportunity to sell customers in a retail environment best understood by the merchant. The loss of in-store purchases to online sales may cause economic problems for traditional small and medium size merchants and the communities they serve. In some neighbourhoods, the number of small retail shops may dramatically decline, leaving community commercial areas in a state of blight and disuse. In addition to economic downturn sensitivities, small, family-owned stores also face extinction threats from sophisticated online retailers, with resultant losses to local community retail diversity and neighbourhood health with the death of the neighbourhood ‘mom-and-pop’ store. Neighbourhood streets may seem vacant during the day and open only after 5 p.m. to serve the interests of only one demographic, namely young urban professionals with disposable income. Previously successful businesses have been closing when e-commerce competition from online auctions and retails attract previously loyal neighbours.

There exists a need for platforms, systems and methods that provide a system that provides non-monetary incentives to neighbourhood customers to engage in neighbourhood brick and mortar, in-person transactions. There exists a need for platforms, systems and methods that may shift sales revenue towards neighbourhood merchants away from electronically competing merchants. There exists a need for platforms, systems and methods that may shift sales tax revenue towards neighbourhood authorities that would otherwise be lost to e-commerce transactions. There exists a need for platforms, systems and methods that may incent local merchants in the community to receive foot traffic from customers that are incidentally doing in-person shopping with other brick and mortar merchants. There exists a need for platforms, systems and methods that provides disincentives to customers who, having only window-shopped local merchants, to then buy on-line from electronic competitor merchants.

Given the foregoing, there are many factors impeding the use of consumer incentives, especially by small and medium sized business merchants. There exists a need for platforms, systems and methods that enables merchants to give non-monetary incentives to their customers who will conduct cash transactions (or other non-acquired account payment methods) with them at their local brick and mortar stores, and allows the merchant to offload the processing burden of managing the non-monetary consumer incentives.

### SUMMARY

Implementations relate to a computer-implemented systems and methods where, for each transaction there is received a transaction time stamp and respective merchant, account holder, and offer identifiers, as well as indicia that payment for the transaction paid for on an non-acquired account (e.g., paper currency, coins, check, etc.). In accordance with some embodiments, for each transaction, systems and methods may also receive indicia that the transaction occurred within the merchant's physical store (instead of an e-commerce transaction).

In accordance with some embodiments, computer-implemented systems and methods may use the respective merchant and account holder identifiers, to retrieve the respective merchant and account holder geographic locations. For each transaction, a determination is made, using the respective merchant and account holder geographic locations, whether the merchant and the account holder have a geographical location in common. A determination is also made as to whether the transaction is being conducted within a predetermined time period by use of the transaction time stamp and the offer identifier.

For each transaction for which the transaction is conducted within the predetermined time period and the merchant and the account holder have a geographical location in common, the merchant identifier is used to retrieve a merchant donation business rule for the merchant to make a donation to an affinity entity, where the affinity entity has a geographical location in common with that of the respective merchant and account holder geographic locations and an affinity entity identifier. A donation to be made by the merchant to the affinity entity for the predetermined time period is derived using the merchant donation business rule, and a message containing the donation is sent to one or more of the merchant, account holder and the affinity entity.

In accordance with some embodiments, within a predetermined audit time period for the predetermined time period, donation receipts are received that each include a currency amount the respective merchant and affinity entity identifiers. For each identifier for the merchant, the sum of the currency amounts of the donation receipts for each affinity entity identifier is calculated to determine whether the merchant has satisfied its commitment to make all donations to all affinity entities.

Variations on the foregoing implementations may include allowing the customer to specify one or more affinity entities in their local community to which donations may be made by merchants with whom the customer conducts cash transaction. In such implementations, each merchant may be given notice of its total periodic donations. Such notice, however, may be given without providing the merchant with any notice or knowledge as to the specific identity of those affinity entities that are to be its recipients. Such implementations leave direction of merchant's donations fully within the discretion of the merchant's customers, limited only by the restriction that the customer can only select affinity entities from among those that serve the local community in common to both the merchant and the customer, while leaving the actual amount of the merchant's donation fully within the discretion of the merchant.

Still further variations on the foregoing implementations may include deriving a donation to be made by the merchant to the affinity entity for the predetermined time period by using the merchant donation business rule as well as donation rules previously specified by the account holder who conducts the cash transaction with the merchant. By way of example, and not by way of limitation, the merchant's donation business rule might choose the amount of the donation whereas the account holder's rule might choose the affinity entity in the community to which the merchant's donation is to be directed.

In yet further computer-implemented methods and computer-system implemented methods, a business process is applicable, without an issuer or acquirer, to a registered member who pays with cash and resides in a community or neighbourhood where a registered merchant's store is also located. The member receives the merchant's offer bearing an identifier which the member shows to the merchant when paying for a transaction in cash, cheque or other non-acquired account. The merchant's Point of Service Terminal (POS) may execute software to acquire indicia identifying the member's cash payment and the identifier for the offer, which may include an identifier for the member. The POS may transmit a time stamp for the transaction with the offer identifier and the cash payment amount, for example. Upon receipt by a server in communication with a network with which the POS is also in communication, a verification may be made as to non-expiration of the merchant's offer, optionally, ‘lift and shift’ day-of-week and time-of-day terms of the merchant e-offer by comparison to the time stamp of the transaction; and identifiers for the of both merchant and member. Upon verification, the server electronically transmits a real time acknowledgement to the respective logical addresses of member and merchant; and the server commits the merchant to make a donation to an affinity entity providing charitable goods and/or service to the community where the registered member resides and the registered merchant's store is located. The server receives subsequent transmission from the affinity entity as to merchant donations received from which the server can ascertain the absence of noncompliance by the registered merchant as to required affinity entity donations.

It will be appreciated that the foregoing summary merely describes exemplary implementations. There may be modifications and variations.

### BRIEF DESCRIPTION OF THE DRAWINGS

Non-limiting and non-exhaustive aspects are described with reference to the following figures, wherein like reference numerals refer to like parts throughout the various figures unless otherwise specified.

FIG. 1 is a flowchart illustrating an exemplary process for making donations to affinity entities incident to transactions paid for with cash or non-acquired account payments;

FIGS. 2 and 3 illustrate schematic diagram of a system for making donations to affinity entities incident to transactions paid for with cash or non-acquired account payments

FIG. 4 illustrates a screen shot characterizing exemplary user interface for receiving input from a merchant and/or the merchant's Point of Service terminal (POS) incident to conducting a cash payment transaction with a customer;

FIG. 5 is a flowchart that illustrates another exemplary process for making donations to affinity entities incident to transactions paid for with cash or other such non-acquired account payments;

FIG. 6 illustrates an exemplary system for processing transactions conducted by merchants with customers, wherein, for each transaction, there is a provision of a service or good by the merchant to the customer for the transaction, where the customer pays for the service or good with cash or other such non-acquired account payment, and there are one or more affinity entities to which contributions are made incident to the transaction; and

FIGS. 7a and 7b illustrate screen shots characterizing exemplary user interfaces for a merchant and a customer, respectively, to designate one or more affinities to whom contributions are to be made incident to each transaction there between.

Implementations will become more apparent from the detailed description set forth below when taken in conjunction with the drawings.

### DESCRIPTION OF VARIOUS EMBODIMENTS

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example, and without limitation, the various programmable computers may be a server, network appliance, set-top box, embedded device, computer expansion module, personal computer, laptop, personal data assistant, cellular telephone, smartphone device, UMPC tablets and wireless hypermedia device or any other computing device capable of being configured to carry out the methods described herein.

Program code is applied to input data to perform the functions described herein and to generate output information. The output information is applied to one or more output devices, in known fashion. In some embodiments, the communication interface may be a network communication interface. In embodiments in which elements of the invention are combined, the communication interface may be a software communication interface, such as those for inter-process communication. In still other embodiments, there may be a combination of communication interfaces implemented as hardware, software, and combination thereof.

Each program may be implemented in a high level procedural or object oriented programming or scripting language, or a combination thereof, to communicate with a computer system. However, alternatively the programs may be implemented in assembly or machine language, if desired. The language may be a compiled or interpreted language. Each such computer program may be stored on a storage media or a device (e.g., ROM, magnetic disk, optical disc), readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the systems and methods of the described embodiments are capable of being distributed in a computer program product including a physical, non-transitory computer readable medium that bears computer usable instructions for one or more processors. The medium may be provided in various forms, including one or more diskettes, compact disks, tapes, chips, magnetic and electronic storage media, volatile memory, non-volatile memory and the like. Non-transitory computer-readable media may include all computer-readable media, with the exception being a transitory, propagating signal. The term non-transitory is not intended to exclude computer readable media such as primary memory, volatile memory, RAM and so on, where the data stored thereon may only be temporarily stored. The computer useable instructions may also be in various forms, including compiled and non-compiled code.

Throughout the following discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. One should appreciate that the systems and methods described herein may involve the execution of transaction and transfer of value between merchants and consumers to provide economic and commercial benefits. One should appreciate that the systems and methods described herein may involve particular configuration of computer hardware components to provide incentives to consumers and transfer value between consumers, merchants and affinity entities. One should appreciate that the systems and methods described herein may involve an interconnected network of computer hardware for transferring electronic data signals and executing transactions.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

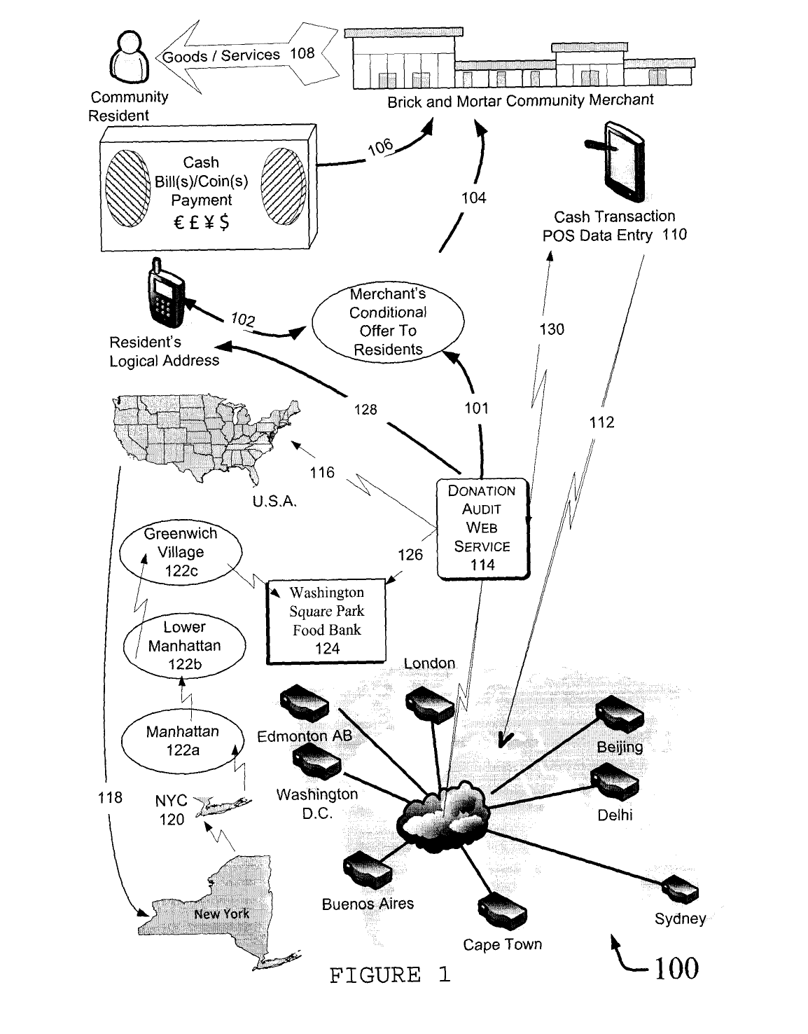

Referring now to FIG. 1, a process 100 is depicted that may be practiced in a global financial transaction system as shown. Process 100 includes a community resident who conducts a financial transaction with a merchant at a brick and mortar store that may be located in the same community where the community resident resides. The community resident conducts the transaction in-person at the merchant's brick and mortar store and pays cash. The community resident may be incentivized to buy from the merchant's brick and mortar store by the merchant's agreement to make a donation to an affinity entity also located in and providing goods and/or services to the local community. By way of example, the affinity entity may be an organization that provides a good and/or service to which both community residences and merchants have an affinity. An illustrative example affinity may be the provision of food and clothing to needy families in the community. Another illustrative example affinity may be the teaching and demonstrating entrepreneurial skills to the community's unemployed. A further illustrative example affinity may be providing venues where sports education can be provided to a local competitors. Yet another illustrative example affinity may be care and feeding of abandoned pets. The affinity may also be the cultivation of good citizenship and public policy. Given the foregoing, the affinity entity may be a for-profit or non-profit organization to which both merchants and customers in the same community have an affinity to advance and promote.

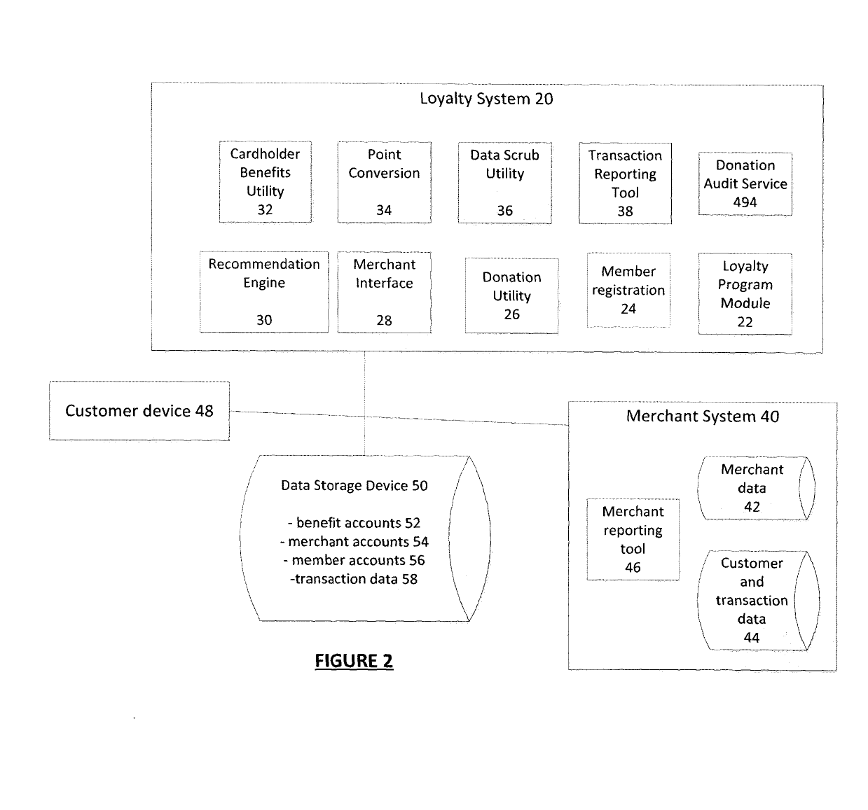

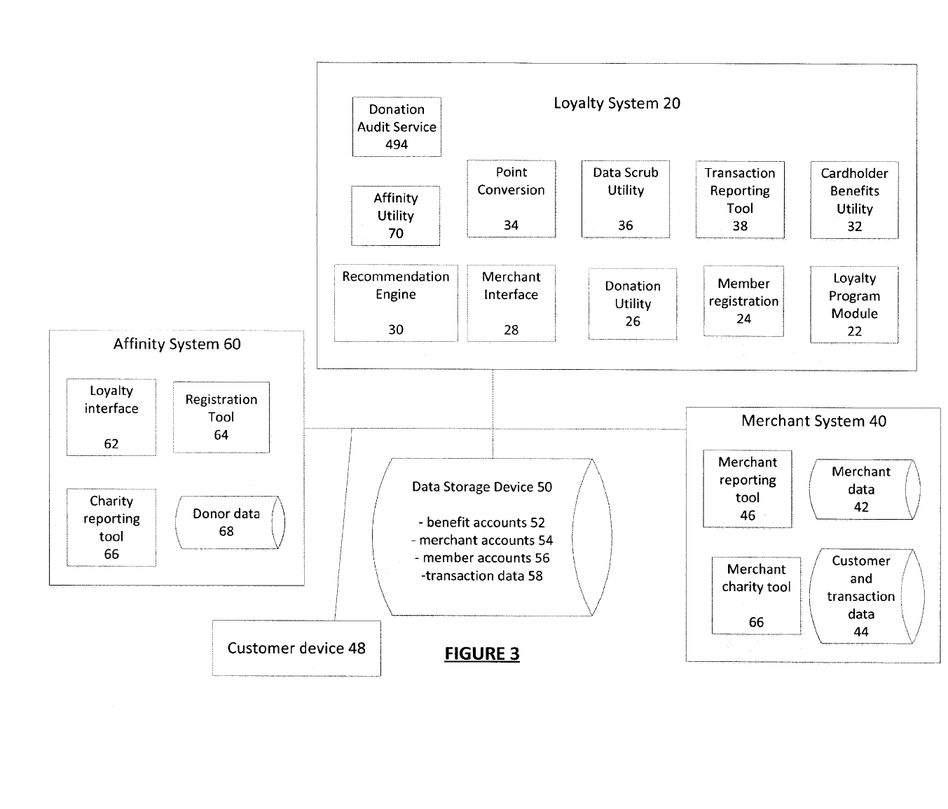

Referring also to FIGS. 2 and 3 there is shown schematic diagram of a system for making donations to affinity entities incident to transactions paid for with cash or non-acquired account payments. Loyalty system 20 interacts with merchant system 40, data storage devices 50, and an affinity system. Examples of non-acquired payments include cash, cheque, electronic currency such as bit coin and so on.

Loyalty system 20 may be implemented using a server and data storage devices 50 configured with database(s) or file system(s), or using multiple servers or groups of servers distributed over a wide geographic area and connected via a network. Loyalty system 20 may be connected to a data storage device 50 directly or via to a cloud based data storage device interface via network. Loyalty system 20 may reside on any networked computing device including a processor and memory, such as a personal computer, workstation, server, portable computer, mobile device, personal digital assistant, laptop, tablet, smart phone, WAP phone, an interactive television, video display terminals, gaming consoles, electronic reading device, and portable electronic devices or a combination of these. Loyalty system 20 may include one or more microprocessors that may be any type of processor, such as, for example, any type of general-purpose microprocessor or microcontroller, a digital signal processing (DSP) processor, an integrated circuit, a programmable read-only memory (PROM), or any combination thereof. Loyalty system 20 may include any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), or the like. Loyalty system 20 may include one or more input devices, such as a keyboard, mouse, camera, touch screen and a microphone, and may also include one or more output devices such as a display screen and a speaker. Loyalty system 20 has a network interface in order to communicate with other components, to serve an application and other applications, and perform other computing applications by connecting to network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these. Although only one loyalty system 20 is shown for clarity, there may be multiple loyalty systems 26 or groups of loyalty systems 26 distributed over a wide geographic area and connected via e.g. network. Loyalty system 20 may be connected to the Internet or other network in order to interact and connect with merchant system 40, customer device 48 and affinity system 60.

Loyalty system 20 includes a cardholder benefits (e.g. incentives) processing utility 32. A cardholder may be a customer of merchant and a member of the loyalty program to receive incentives to for cash payments at a brick and mortar store. In one example of an implementation, the cardholder benefits processing utility 32 may be a software component of a web utility that provides a loyalty engine. Accordingly, cardholder benefits processing utility 32 may be referred to as a loyalty engine. The cardholder benefits processing utility 32 may be programmed to configure the data storage device database 32 with benefits accounts 52 of the various cardholders who are members of the loyalty program. The benefits accounts may comprise a record of incentives for the member, along with details of transaction associated with incentives and customer attributes and preferences (such as e.g. location data, preferred affinity entity data).

The loyalty system 20 may be programmed to configure the data storage device 50 with merchant accounts 54 of the various merchants who are registered with loyalty system 20 to provide loyalty programs and offer incentives or benefits to encourage cash payments and in-store transactions through donations to affinity entities.

The loyalty system 20 may be programmed to configure the data storage device 50 with card or member accounts 56 who are registered with loyalty system 20 to provide loyalty cards to cardholders for loyalty programs. The loyalty cards may be physical cards with computer readable indicia to identify the cardholder, and may also be an electronic card for storage on storage device of mobile device or smart phone of cardholder. The loyalty card may be associated with a value account for the merchant for payment of transactions with merchant.

Access to different aspects and account records of the data storage device 50 may be provided by an administration utility (not shown) that enables hierarchical access to the data storage device 50, depending on permissions assigned by the operator of the loyalty system, to each of members, and merchants. The purpose of providing this access is to provide transparency to the benefits being provided to members who are cardholders by operation of the loyalty system 20.

Loyalty system 20 further includes a reporting utility or transaction data reporting tool 38, which may be further linked to the cardholder benefits processing utility 32 and data storage device 50 to provide various reports of interest to merchants and cardholders. For example, transaction data reporting 36 may permit merchants to generate reports on measured performance of benefits or incentives provided to them by the loyalty system 20 in their sphere of interest. Merchant system 40 may receive the report via merchant interface 28 and merchant reporting tool 46. One of the purposes of the reporting utility 36 is to enable the organizations linked to the loyalty system 20 to calibrate their involvement (e.g. by merchants calibrating the benefits that they provide) targeted to cardholders, and to review the results of their loyalty programs management by loyalty system 20.

Loyalty system 20 may include program module 22 which may be a hardware and software tool to manage the various loyalty programs managed by loyalty system 20. Loyalty programs may be particular to one or more merchants. A loyalty program may be used to provide incentives or offers to the customer or members.

In example embodiments described herein, merchant system 40 may be provided with tools to design and implement their own loyalty programs, design and implement their own benefits or incentives, including cross-promotional programs in conjunction with other merchants in the same community for example. The merchant system 40 may design and implement loyalty programs and incentives using merchant interface 28. Merchant system 40 may transmit merchant data (e.g. parameters for reports) to loyalty system 20 via merchant interface 28. Merchant system 40 may transmit customer and transaction data 44 (e.g. data regarding transactions and customers) to loyalty system 20 via merchant interface 28.

Each customer may be associated with a market or demographic, which may be used by merchant system 40 and loyalty system 20 to customer incentives and offers. A loyalty program incentive may be used to target particular consumer needs. Loyalty system 20 may recommend incentives via recommendation engine 30 tailored to segments of customers, where the recommendation may be based attributes of customers, such as spending habits, interests, needs, wants, charities, social habits, etc. Loyalty system 20 may recommend affinity entities based on customer attributes or merchant attributes, such as location, partnerships, goods and services, spending trends, interests, needs, wants, charities, social habits, etc.

The loyalty system 20 is operable, via the Internet for example, to engage in real time data communications with a merchant system 40, and also customer or member devices 28 (e.g. electronic device, smart phone, mobile device, laptop, tablet, or other computing device). Accordingly, seamless data flows between these systems can be established in order to enable the capture of financial transactions and cardholder data, and also the accrual of benefits or incentives based on data provided to the loyalty system 20 the merchant system 40.

Loyalty system 20 is operable to provide system tools for the affinity system 60 to receive payments from the merchant systems 40 in connection with transactions between the merchants and the cardholders registered with the loyalty system 20. The reporting facility provides visibility to the affinity entity, the cardholders, and the merchant in regard to the amounts accrued and subsequently paid as donations at the end of the measurement period.

The loyalty system 20 may pre-determine the conditions under which this occurs. Typically, incentives or offers are associated with conditional transactions with merchants (e.g. the purchase of a particular good or service is required in order to receive the special offer or prize, cash payments, in-store transactions). This encourages cardholders to conduct transactions with merchants. When a registered cardholder enters into such a transaction with a merchant in connection with the loyalty system 20, a transaction amount is recorded. At the end of the reporting period the system aggregates the amounts for reporting purposes, and for calculating donations. Funds may distribute to the respective affinity systems 60.

Loyalty system 20 may recommend incentives particularly tailored to targeted segments of cardholders and potentially cardholders to further increase particular transactions. The recommended incentives and associated transactions are likely to be of interest to the targeted segment based on data mining and correlations of cardholder (and potential customer and cardholder) attributes.

The end result may be the accrual of benefits and incentives the to the benefits account 34, which then in is disbursed on a periodic basis to the applicable parties.

Loyalty system 20 provides for a linkage of a data between merchant systems 40 and cardholders. Although only one merchant system 40 is shown in FIG. 2 for simplicity, there may be multiple merchant systems 40 connected to loyalty system 20.

Loyalty and customer acquisition programs may be required to continually acquire new members, preferably at a low cost, e.g. through organic growth or through a partnership with various customer sources. Loyalty system 20 may retain cardholder databases of transaction information and other cardholder benefits, which may include data from other participating merchants. Loyalty system 20 may access the cardholder databases to detect cardholder attributes in order to recommend incentives via recommendation engine 30.

Transaction data 58 may include (1) customer name; (2) payment method; (3) date of transaction; (4) merchant ID; (5) amount of purchase; and (6) goods and services. Other information may also be accessible such as demographic and geographic information relating the cardholder. This information may be stored in data storage devices 50 and accessed by loyalty system 20.

Loyalty system 20 enables each of the merchants and members to track the accrual of benefits by means of transactions that in connection with the loyalty system 20 result in the accrual of loyalty benefits (e.g. incentives).

Loyalty system 20 is operable to store the data items mentioned above (and other similar data items) to the data storage device 50 and apply same against transactions between participating members and participating merchants. Loyalty system 20 may use the data items to recommend incentives or affinity entities, and corresponding transactions.

The point conversion utility 34 enables enhancement of loyalty programs based upon points or donations as cardholder benefits created by cardholder use in connection with a loyalty program and provided by incentives offered to cardholder. The point conversion utility 34 may allow the merchant to reward their cardholders in form of donations by converting loyalty program points to donation amounts. These points, donations, and rewards are examples of incentives. For example, point conversion utility 34 may calculate 100 points for a transaction and record the transaction information and related conversion amount 100 points as cardholder attributes in storage device 50.

An example process in connection with the generation of reports based on the contents of data storage device 50 will now be described. A system administrator of the operator of the loyalty system 20 may access certain reports in connection with merchant activity in connection with customer demographics. Similar processes and system implementations may be used to generate other reports of information accessible to merchants, or members. The loyalty system 20 is operable to generate reports for merchants to track the use and monitor the results.

Loyalty system 20 may enable a merchant to target incentives to particular sub-groups of cardholders, depending on their interest (e.g. cardholder attributes) to merchant.

After a cardholder transaction has been completed the transaction data may be relayed to the loyalty system 20. The loyalty system 20 defines in accordance with a particular loyalty program a set of rules to complement loyalty programs by processing the transaction data (e.g. identified merchant, amount of transaction, date of transaction, time of transaction) to convert the transaction into points in connection with parameters set by each participating merchant. For instance, the system 20 may convert transaction incentives or prizes within the loyalty program to points to the cardholder based on a pre-determined formula. The loyalty system 20 would for example convert a $100.00 spent by a cardholder under a loyalty program into 100 points if the transaction was completed between the hours of 00:00:00 and 12:00:00 Monday through Friday and 50 points at any other time for the particular card used at a particular merchant.

As previously stated, a merchant belonging to the loyalty system 20 may choose to offer rewards/incentives based upon time of day and date. The incentives may also be based on a particular good or service. The merchant provides selected information relating to particular demographics, affinity entities, transactions, dates and times (e.g. attributes). The loyalty system identifies the merchant, the time of day and the date and applies differential incentives through the loyalty system. The incentives may relate to a donation to an affinity entity as managed by donation utility 26.

Benefits or incentives may be accrued on behalf of members (including members who are cardholders) in a number of ways. The benefits themselves can vary. For example, pre-set benefit application or payment rates are associated with particular transactions associated with the loyalty system 20.

Within the loyalty system 20, merchants may be motivated to develop new and innovative loyalty programs (through the use of recommended incentives) that will automatically be accessible to cardholders. Loyalty system 20 may provide a means of generating financial transactions and/or customers for merchants.

Loyalty system 20 may provide flexibility in the arrangements made by the merchants, as it relates to the benefits provided to cardholders who become members. These arrangements can define the pre-determined benefits associated with particular transactions, e.g. a per transaction benefit to the cardholder.

Other implementations and extensions may be implemented by loyalty system 20. For example, various security methods and technologies for restricting access to resources of the loyalty system 20 to those authorized to do so by the operator of the loyalty system 20 may be used. Loyalty system 20 may use various existing and future technologies to process payments by operation of the transaction utility. Loyalty system 20 may provide various tools and interfaces for interacting with the loyalty system. The system 20 may also allow for robust reporting which may include comparative reports of member affinity or of transaction history with participating merchants. In other words, member transaction history may be different for differing groups of members based on member affinity.

Data storage device 50 maintains benefits accounts 52, merchant accounts 54, member accounts 56, transaction data 58 for storing attributes regarding merchants, cardholders and transactions. The attributes may be used to determine incentives to offer in relation to various loyalty programs, and affinity entities to provide donations to. For example, data scrub utility 36 may retrieve data from data storage device 50 for provision to recommendation engine 30 to recommend incentives involving donations to affinity entities. Data scrub utility 36 may normalize, scrub, convert and perform other operations on data received from other systems.

Cardholder registration 24 may enable cardholders to register for loyalty programs. Cardholder registration 24 may populate cardholder and transaction data 56, 58 based on data collected from registration. The Merchant reporting tool 46 may generate reports based on cardholder and transaction data 58 and data maintained by loyalty system 20 as part of data storage device 50. Data storage device 50 may maintain a copy of cardholder and transaction data 58, or may contain separate data. Loyalty program module 22 may be used to create and manage various loyalty programs for merchant system 40.

Loyalty system 20 may include a merchant interface 28 for interacting with merchant system 40 and generating various interfaces for display on merchant system 40. The merchant interface 28 may provide a mechanism for merchant system 40 to create, customize, and manage loyalty programs and incentives. Data scrub utility 36 may normalize, scrub, convert and perform other operations on data received from merchant system 40.

Merchant system 40 may be configured with various computing applications, such as merchant reporting tool 46 for generating reports regarding loyalty programs and for displaying interfaces received from merchant interface 28 to create, customize, and manage loyalty programs and incentives, and view donation results for affinity entities, and so on. A computing application may correspond to hardware and software modules comprising computer executable instructions to configure physical hardware to perform various functions and discernible results. A computing application may be a computer software or hardware application designed to help the user to perform specific functions, and may include an application plug-in, a widget, instant messaging application, mobile device application, e-mail application, online telephony application, java application, web page, or web object residing, executing, running or rendered on the merchant system 40. Merchant system 40 is operable to authenticate merchants (using a login, unique identifier, and password for example) prior to providing access to applications and loyalty system 40. Merchant system 40 may be different types of devices and may serve one user or multiple merchants. Although merchant system 40 is depicted with various components in FIG. 1 as a non-limiting illustrative example, merchant system 40 may contain additional or different components, such as point of sale system or other transaction processing system.

Merchant system 40 may include one or more input devices, such as a keyboard, mouse, camera, touch screen and a microphone, and may also include one or more output devices such as a display screen and a speaker. Merchant system 40 has a network interface in order to communicate with other components, to serve an application and other applications, and perform other computing applications by connecting to network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these. Although only one merchant system 40 is shown for clarity, there may be multiple merchant systems 40 or groups of merchant systems 40 distributed over a wide geographic area and connected via e.g. network.

Merchant system 40 includes data storage devices storing merchant data 42 particular to the merchant, such as geographic location, inventory records, historical records, and the like. Data storage devices may also store customer and transaction data 44 such as customer names, addresses, contact information, target potential customers, transaction details, and so on.

Merchant system 40 may also include a kiosk or customer interface device to receive data from customers and determine location of customers (e.g. a customer is present in-store). This data may be used as the location identifier for the customer. This data may also be used to trigger the incentive and donation, as the kiosk or customer interface device provides a mechanism to verify that the customer is present at the brick and mortar store. Merchant system 40 may also include near field communication (NFC) technology to detect that customer device 48 is present in a brick and mortar store of merchant to trigger donations and incentives.

Customer device 48 may include processor and data storage devices. Customer device 48 may include one or more input devices, such as a keyboard, mouse, camera, touch screen and a microphone, and may also include one or more output devices such as a display screen and a speaker. Customer device 48 has a network interface in order to communicate with other components, to serve an application and other applications, and perform other computing applications by connecting to network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these. Although only one customer device 48 is shown for clarity, there may be multiple merchant systems 40 or groups of customer device 48 distributed over a wide geographic area and connected via e.g. network. Customer device 48 is configured with GPS, NFC or other location detection hardware to determine location of customer (e.g. location identifier) and to verify if the customer is present in a brick and mortar store of merchant.

Loyalty system 20 (and in particular charity utility 26) may interact with an affinity system 60 to provide charitable incentives (e.g. an incentive involving a donation by the merchant to an affinity entity). Affinity system 60 may include a data storage device with donor data 68. Charity system 60 may include a loyalty interface 62 for generating interfaces populated with data from loyalty system 20.

For example, a correlation may be made between donor data 68 and benefits accounts 52 or card holder data 58 to determine whether any donors are also cardholders. If so, then recommendation engine 30 may recommend an incentive with a donation portion to the affinity entity associated with affinity system 60.

Affinity system 60 may include a registration tool 64 to register users to become donors, and potentially cardholders of a loyalty program created by loyalty system 20. The registration tool 64 provides a mechanism to collect attributes regarding donors.

Affinity system 60 or affinity utility 70 is operable to identifying donors associated with an affinity entity. The donors may be cardholders or potential cardholders for a loyalty program provided by loyalty system 20. The donors are associated with attributes, such as the example attributes described herein in relation to cardholders.

Affinity system 60 or affinity utility 26 is operable to determine which donors are cardholders and which are not. Affinity system 60 or affinity utility 26 is operable to invite those donors which are not cardholders to participate in a loyalty program offering incentives that include donations to the affinity entity. These may be recommended incentives based on their past donations.

Affinity system 60 or affinity utility 26 is operable to identify a merchant and a transaction. This may occur prior to 112 or after in different embodiments. Affinity system 60 may contact a merchant upon detecting that a subset of donors are also customers, potential customers, or cardholders to arrange for an incentive provided by merchant that includes a donation to the affinity entity. The transaction may identify a good or service of interest to the donors based on the attributes.

Affinity system 60 or affinity utility 26 is operable to select an incentive based on the affinity entity, the attributes, the merchant, and the transaction. The incentive defines a benefit provided by the merchant to the affinity entity upon the occurrence of a transaction involving the merchant and one or more donors. In this way, a donor is motivated to transact with the merchant due to the donation provided to their preferred affinity entity. Affinity system 60 or affinity utility 26 may contact donors encouraging them to transact with a merchant, as this may result in an increase in donations to the affinity entity. The merchant may have access to a new set of potential customers via affinity system 60. The loyalty system 20 may consider the buying patterns of donors to recommend incentives with a donation component. This also allows merchants to see what customers are also donors and tailor incentives accordingly.

Affinity system 60 may be used to manage events and the attendee list may also receive the recommended incentive. This may increase transactions for merchants, as well as increase donations if there is an additional incentive offered by merchants. The merchant and charity may set a donation rate which may be a fixed or proportional amount. For example, a percentage of the transaction amount may be given as a donation.

Referring back to FIG. 1, at reference numeral 101 of Process 100, a Donation Audit Web Service 114 sends a local merchant's conditional offer or incentive to a logical address of the community resident as indicated at reference numeral 102. The Donation Audit Web Service 114 may be an integral part of loyalty system 20 or may be coupled thereto. The incentive, which can be retrieved from storage in a merchant offer record in data storage device 50 in communication with the Donation Audit Web Service 114, is sent in a transmission and includes an expiration date. The expiration date may be subsequently used with a time stamp of any transaction between the community resident and the merchant in order to determine validity of the offer and non-expiration of the merchant's obligation to make a donation to a local charity or affinity entity.

At step 104, the community resident takes the local merchant's conditional incentive to the local merchant's brick and mortar store. The incentive may be on a physical material (with machine readable code) or may be an electronic incentive residing on customer device 48. After showing/scanning/transmitting the incentive to the merchant, the community resident conducts a transaction that is paid for by cash 106 in order to buy goods and/services 108 received by the community resident. The merchant input data about the transaction into a Point of Service terminal (POS) seen at reference numeral 110. The POS may be an integral part of merchant system 40 or may be coupled thereto. The POS, for example, can be a cash register or a web enabled mobile device (e.g., a tablet computing device). The POS 110 transmitted the input data in transmission through a global telecommunication processing system back to the Donation Audit Web Service 114. The input data may be stored in data storage device 50 as transaction data 58 for further processing and subsequent retrieval.

Donation Audit Web Service 114 uses transaction data 58 from the transaction in the transmission to determine whether the merchant and its customer have the same local community by using data in the transmission that includes respective identifiers for the merchant and its customer. These identifiers can be accorded to the merchant and its customer during or prior to any cash transaction there between, and when each is registered with or otherwise signed up for participation with the Donation Audit Web Service 114 via member registration utility 24. This registration process will include the collection of physical and local addresses for each. As described, location determination and verification mechanism may be used to verify that the customer is present at the brick and mortar store including GPS, NFC, kiosks, smart devices, and so on.

Once physical address information is known, the local community of each can be determined. The local community determination can be made on any of several different methods, or combinations thereof. Once such method is political in that the merchant's place of business is in the same political or legal division as that of its customer's residence, such as the same province, state, county, prefecture, city, or borough. Another such comparison can be whether the merchant's place of business has a postal code that is the same or within a predetermined proximity as that of its customer's residence.

Yet another such comparison can be whether the merchant's place of business and its customer's residence are physically proximate within a predetermined factor by any of a variety of measures or combinations thereof. For example, latitude and longitude coordinates might be known for both the merchant's place of business and the residence of its customer. These coordinates can be used to determine whether the linear distance there between is within a predetermined distance to ascertain whether or not the merchant and its customer share the same local community. Alternatively, a navigation algorithm, using any of various different travel methods (e.g., walking, automobile, bicycle, mass transit, etc.) can be used to determine whether the time, using one or more travel methods, is within a predetermined time limit to ascertain whether or not the merchant and its customer share the same local community.

Still another such comparison can be whether the merchant's place of business and its customer's residence are proximate according to voting, electoral, or political districts. The district use can be determined by an official method, an unofficial method, or a combination of method. By way of example, measurements known within the political gerrymander sciences can be used, including but not limited to a minimum district to convex polygon ratio, shortest split line algorithm, minimum isoperimetric quotient, etc.

The local community corresponding to that of the merchant and its customer, and separations there between (if any), may be determined from any combination of linear distance, mode of transportation travel time, political separation, postal designation, and/or hybrid algorithm that takes into considers geographic barrier features such as rivers, cliffs, and highways, cultural features such as boundaries of identified people groups (e.g., tribes, first nation people, etc.), land ownership such as subdivisions, housing projects, cooperatives, planned communities, military installations, governmental owns and leased properties, etc. Given the foregoing, an algorithm might find that the merchant and its customer are members of the same community, not members of the same community, or are both members of more than one of the same communities as determined by the algorithm.

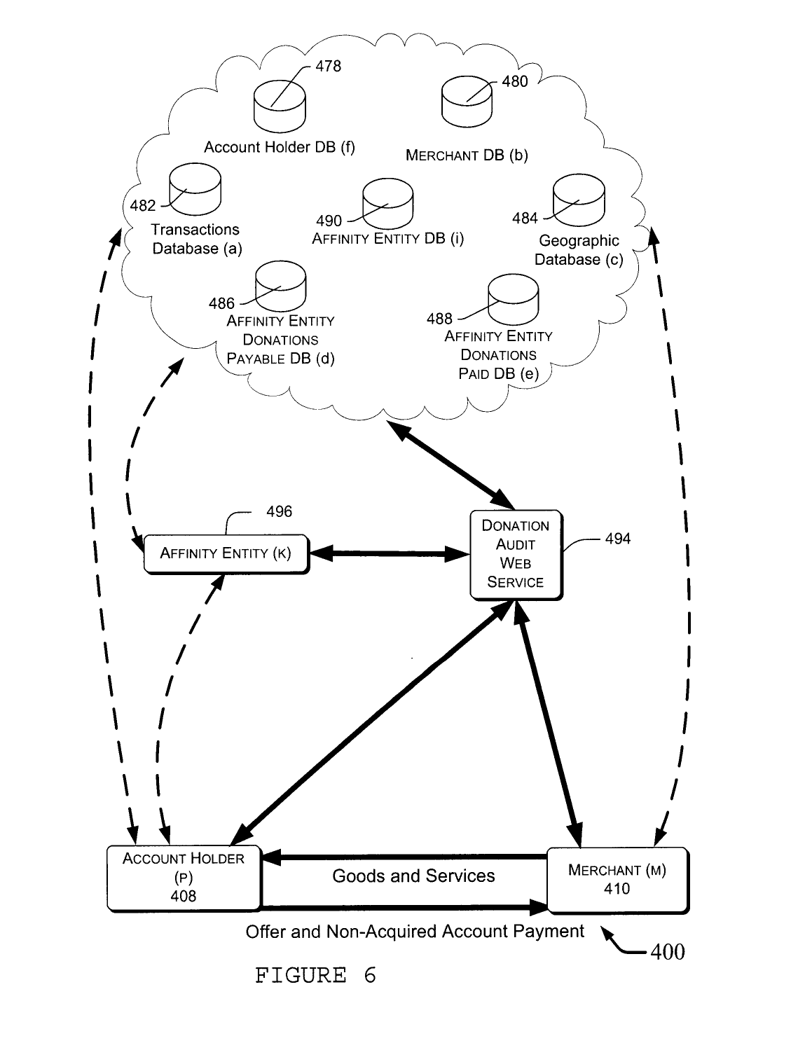

Similar, or like, or different algorithms, may be used to determine the respective local community of the merchant and its customer can be used to determine the local community of an affinity entity such as that shown on FIG. 1 at reference numeral 124, or as that shown as an Affinity Entity (k) 496 in FIG. 6, each of which is discuss herein below. Affinity Entity may be associated with affinity system 60. If the local community of the merchant, its customer, and the affinity entity selected the customer are the same, then the business rule selected by the merchant will determine the amount of the donation that the merchant will make to the affinity entity selected the customer.

In some implementations, the affinity entity to whom a merchant is to make a donation may only be selected the customer, and not the merchant. In such implementations, tensions between affinity difference between merchant and customer are reduced. Moreover, the merchant need not be told or be given any notice, directly or indirectly, as to the identity of the affinity entity selected by the customer with whom the merchant is conducting a cash transaction. Rather, the merchant might only be told or be given notice to make a single payment of or period payments to a single affinity entity that will thereafter make respective disbursements for all registered merchants accordingly to those affinity entities that had been selected those customers with whom those merchants had conducted cash transactions. Loyalty system 20 may be used for disbursements between merchant systems 40 and affinity systems 60. A merchant who does not want to make a donation to a particular affinity entity need not do so directly, as any and all merchant donations are made blindly through the single affinity entity (e.g. associated with an affinity system 60) that make all disbursements to all affinity entities. Accordingly, each merchant may have notice of its total periodic donations to the affinity entity without knowing the identity of the recipients, thereby leaving direction of donations to fully within the discretion of the merchant's customers, limited only by the restriction that the merchant's donation must be made to an affinity entity serving the local community of both the merchant and its customer, while leaving the actual amount of the merchant's donation fully within the discretion of the merchant.

Referring again to FIG. 1, Donation Audit Web Service 114 using respective identifiers for the merchant and its customer to access and retrieve geographic information for each, then applies computing control logic to the retrieved geographic information to determine the respective local communities of the merchant and its customer. As shown in FIG. 1, the local community can be progressively granular in nature, such as first the United States of America as shown at reference numeral 116, then the state of New York as shown at reference numeral 118, then the city of New York as shown at reference numeral 120, then the combined boroughs of Manhattan as shown at reference numeral 122a, then a portion of the combined boroughs of Manhattan that is lower or downtown Manhattan as shown at reference numeral 122b, and then the specific borough of Greenwich Village as shown at reference numeral 122c. This final level of geographic granularity indicates a community in which both merchant and customer are members.

The final level of geographic granularity can is used to perform lookup to identify: (i) the affinity entity or charity for that community which, as shown at reference numeral 124, is the Washington Squire Food Bank, has been specified by the customer; and (ii) the respective identifier of the merchant's business rule (and/or the customer's business rule) that is to be used to make a calculation of the donation that the merchant makes to the affinity entity or charity for that community. The transfer of the donation may be directly between merchant system 40 and affinity system 60, or via loyalty system 20. The business rule(s) is/are used with the currency amount of the customer's cash payment to calculate the donation that is to be made by the merchant to the affinity entity or charity for that community. Note that the donation can be directed to a plurality of affinity entities for the local community according to directs that were specified by the customer. For example, the customer may have specified that each merchant donation is to be split evenly, or in specified portions, between five (5) local community affinity entities, for example: (i) a local youth sports team cooperative; (ii) a local charter junior high school; (iii) a local house of worship; (iv) a local political party; and (v) a local for-profit college specializing business entrepreneurialism.

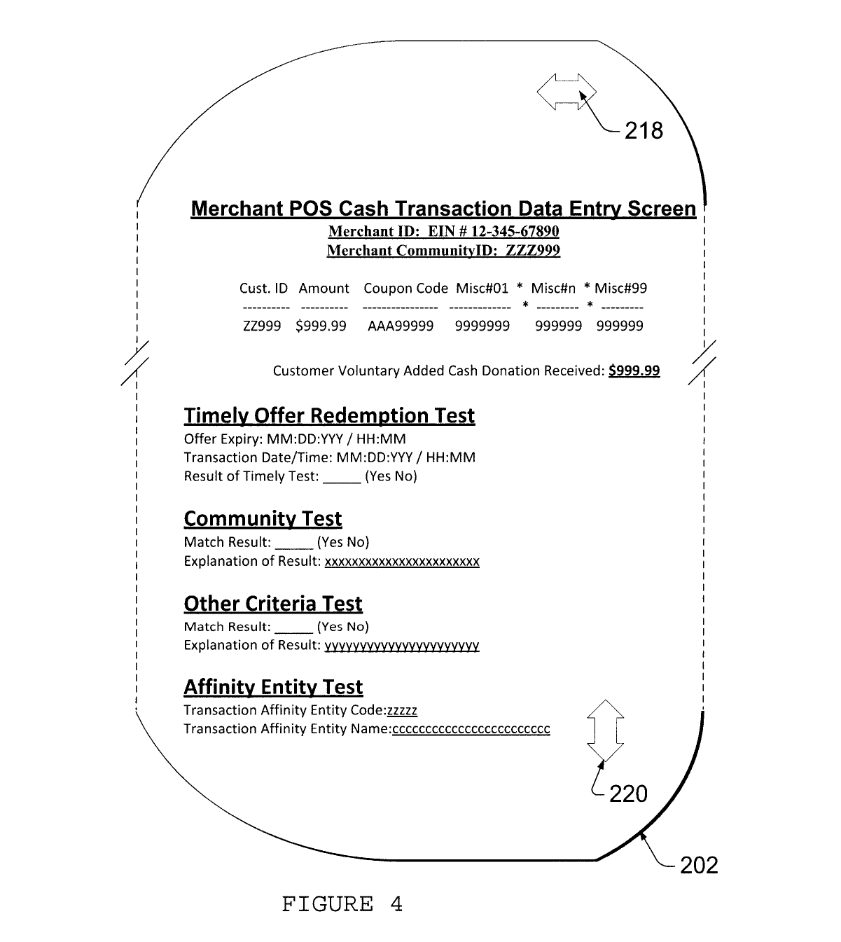

Optionally, the data input into POS 110 can include additional cash received from the customer by the merchant that is also to be donated by the merchant to the affinity entity or charity for that community. More discussion of such implementation features are discuss with respect to FIG. 4. A cash indicia or identifier may form part of the transaction data 58 to determine whether an incentive for a donation to an affinity entity should be triggered. The cash indicia may be automatically determined as a result transaction data not including particular details regarding a debit card, credit card or other acquired account details. That is, loyalty system 20 may infer that cash or other non-acquired payment method was used for the transaction when the transaction record does not include details regarding an acquired account.

The Donation Audit Web Service 114 retains the derived donation for subsequent audit purposes to insure compliance by each community merchant in its donation commitments to each of the one or more affinity entities or charities for each community that the merchant and/or its customers is a member. The Donation Audit Web Service 114 also transmits a message containing notice of a donation, or the particularly derived donation, for the customer's cash transaction, as shown at reference numerals 126, 128, and 130, respectively to logical addresses of the affinity entity or charity for that community, the community resident and the merchant.

Referring now to FIG. 4, a screen shot 202 shows a user interface for POS 110 seen in FIG. 1. The user interface may be generated via merchant interface 28 and merchant reporting tool 46, for example. Screen shot 202 can be used to receive input at POS 110 from the merchant, where the input is generated incident to the merchant conducting the cash payment transaction with the community resident.

The top of screen shot 202 may show identifiers for the merchant and its community. The merchant enters data in field shown on screen shot 202 that include, from left to right of FIG. 4, an identifier for the customer, a total currency amount of cash paid by the customer for the transaction, an identifier for the offer from the merchant to the customer (e.g., a Coupon Code), and one or more miscellaneous data entries into respective fields Mics#n, where ‘n’ in an integer from 0 to 99. Alternatively or additionally, merchant reporting tool 46 may automatically populate one or more fields of interface with data stored or derived from data storage device, customer device 28 and other computing devices.

Optionally, a field may be provided as shown in screen shot 202 into which data can be input to designate additional cash, over and above the total currency amount of cash paid by the customer for the transaction, as received from the customer by the merchant that is also to be donated by the merchant to the affinity entity or charity for that community.

Data received as input into the fields of screen shot 202 may be used to look up parameters, business rules, geographic locations, and other relevant data to be processed incident to the transaction between the merchant and the customer. The identifier for the offer from the merchant to the customer can be used to look up a validity time period or expiration date of the offer against which the current date and time of the transaction is compared to validate the offer. Other input data received from fields in screen shot 202 can be used to look up the merchant business rule that is used to derive a donation that the merchant is obligated to make an affinity entity in a geographic location also identified from input data received from fields in screen shot 202.

The result of the look-ups, comparisons, and validations may be reflected in data output into fields for display to the merchant and its customer on screen shot 202. For instance, the date and time of the transaction may be invalid for the offer retrieved by looking up the corresponding Coupon Code. Also by way of example, if the look up of the respective identifiers for the merchant and customer shown that their respective communities are not the same, then the screen shot 202 may reflect the result of this test, thereby indicating that the merchant is not obligate to make a donation to any affinity entity. Of course, other input can be used to do other look-ups, validations, and tests the results of which can be displayed on screen shot 202 with respective explanations.

Screen shot 202 can provide input and selection of data for a typical user POS experience, including but not limited to keyboard data entry, pull down menus, pictograph scanning with an optical reader device as read from print or electronic media rendering, etc. Horizontal 218 and vertical 220 panning can be user activated to move that portion of the display being rendered horizontally and vertically, respectively.

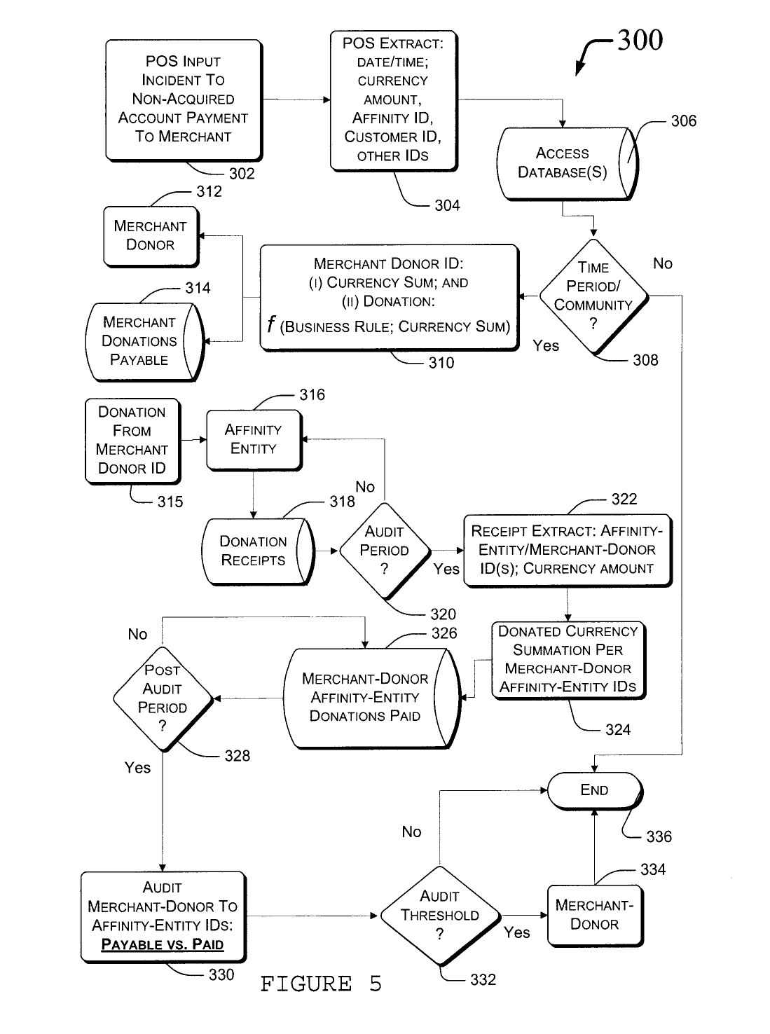

Referring to FIG. 5, a flowchart illustrates a Process 300 for using local merchants' commitments to make charitable contributions to local charities as incentives to local residents to conduct cash transactions with the local merchants. Prior to step 302 of Process 300, as discussed above with respect to FIGS. 1 to 4, a local community resident may conduct a cash transaction at a brick and mortar store of a local community merchant. At step 302, input of data from the cash transaction is received as input data, such as described above with respect to FIG. 4, or otherwise received by system. This input may include data extraction at step 304 by the POS, including, by way of example and not by way of limitation, the current date and time, a total currency amount of cash paid by the customer to the merchant, respective identifiers for the customer, the local affinity entity or charity, etc. The customer device 48 may provide data to POS or merchant system 40 for use as input data.

Identifier(s) retrieved at steps 302-304 can be used to access one or more databases at step 306. Validity of the current date and time for the offer presented by the customer to the merchant is assessed in a query at step 308. While an invalid offer determination ends Process 300 at step 336, Process 300 proceeds to step 310 when the offer is valid as determined at query 308.

At step 310, rules for calculating a donation to be made by the merchant (via merchant system 40) to the local affinity entity are retrieved using data acquired in steps 302-304. The donation utility 26 may implement a rules engine with rules for calculating donations. The rules may be associated with different merchant identifiers so that donations may be calculated specific to different merchants. This calculation can include steps to access one or more databases (stored and managed by data storage device 50) as shown at reference numerals 312-314, including transmitting to and/or storing the calculated donation to merchant donor 312 and/or one or more merchant donations payable databases 314. The donation rules may store as part of merchant account 54 at data storage device 50 for access by donation utility 26. A merchant identifier may be used to locate the rules particular to a merchant system 40.

Subsequent to the cash transaction as processed in steps 302-314 of Process 300, the local merchant (via merchant system 40) makes the calculated donation to the local affinity entity (via affinity system 60 or loyalty system 20) as shown at step 315. The local affinity entity, as shown at step 316, sends notice of the donation's receipt for storage in one or more databases as shown at step 318. The donation receipt may form part of merchant account 54 at data storage device 50.

After a predetermined audit time period as passed as determined by a query at step 320, an audit is conducted to insure compliance by each community merchant in its donation commitments to each of the one or more affinity entities or charities for each community that the merchant and/or its customers is a member. This audit can include adding up all required donations for each local merchant to each local affinity entity or charity as shown at step 322. The donation summation for each local merchant to each local charity derived at step 324 is compared to information in one or more databases 326 to ascertain compliance of each merchant with its donation obligations. Stated otherwise, the local merchant has a certain amount of time after a predetermined audit period, as determined at step 328, by which to make all of the merchant's donation obligations to local affinity entities.

Differences between donations paid and donations still payable by each local merchant are calculated by donation utility 26 at step 330, which differences are subjected to an audit threshold query at step 332. If a local merchant's donations paid is non-compliant with donations still payable, then Process 300 moves to step 334 to notify the local merchant accordingly of its deficiency. That is, loyalty system 20 is operable to generate notifications for transmission to merchant system 40 regarding outstanding donations payable. Otherwise, an affirmative results at query 332 causes Process 300 to terminate at step 336 which may also include notice of compliance being transmitted to each such complaint local merchant, its customers, and/or each of the local affinity entities, either by way of summary report, donations to respective affinity entities by the merchant, and variations thereof.

To summarize Process 300 in various implementations thereof, data is extracted from input at a local merchant's brick and mortar located POS (e.g. merchant system 40), such as chronological information pertaining to the transaction including date and time, a currency amount of the transaction, and any other data desired to assist in making a charitable donation By way of example, an identifier for the merchant can be extracted, as well as an identifier for the local community resident as offered to the merchant by the same. The account number, by way of non-limiting example, can be a Bank Identifier Number or BIN code for a credit or debit card that is kept by the merchant in a ‘card-on-file’ database. The merchant identifier may be used to retrieve donation rules for the particular merchant at merchant account 54.

Using the merchant and/or account holder identifiers extracted from the POS data, more information, such as respective identifiers for donors, can be looked up for the charity or affinity entities via access to one or more databases (e.g. data storage device 50) at step 306. The lookup may be implemented by loyalty system 20 using data storage device 50, or through data exchange between loyalty system 20 and affinity system 60. Donation utility 26 can retrieve business rules used to calculate one or more donations that are to be made to the charity or affinity entities by one or more donors respectively corresponding to the account holder or the merchant. Stated otherwise, the donation will be a function of the amount of the transaction and the retrieved business rule(s).

Donations, per extracted donor IDentifier (ID), are made for those transactions that occur during a predetermined time period and/or within a predefined geographic location as determined by a query (not shown). If the result of geographic query is affirmative, process 300 moves to step 310 where the donations for the donors are calculated as a function of the respective business rules. Otherwise, no donation is made and process 300 terminates at step 336.

Donations calculated at step 310 are communicated to the local merchant donor at step 312 and stored in a donations payable database 314 (e.g. at data storage device 50). Thereafter, donations 315 are received at affinity entities at step 315 from donors identified by either respective donor IDs, which can be the identifier for the merchant. Donations received are stored in donation receipts database 318. Data from donations that are made by donors via communication to affinity entities during an audit period, as determined at query 320, is extracted at step 322. The donation related data that is extracted at step 322 can include the donor ID, and the currency amount of the donation. During the audit period, a sum of donations to each charity made by each local merchant donor for the audit period is calculated and stored in a donor-charity donation paid database 326. After audit period, as determined by query 328, differences in donations paid are compared to donations payable for each donor at step 330. Differences exceeding a predetermined audit threshold, as determined by query 332, are communicated to the respective local merchant donors at step 334. Of course, the charitable audit functions, such as have been described above, can be performed by an agent of any donor and/or of a loyalty system organization charged with implementing all or portions of process 300. Such an auditing agent can be, by way of non-limiting example, a certified public accountancy agency, a non-government regulatory agency, a governmental agency, and the like.

As mentioned with respect to various implementations, a donation mechanism can be set up such that the Merchant-Donor 334 makes blind donations, either directly or indirectly (via loyalty system 20 or affinity system 60), to a single donation disbursement entity (e.g. affinity system 60) who in turn disburses the donations to those affinity entities selected by the customers of the Merchant-Donor 334. This donation mechanism provides neither knowledge nor notice to Merchant-Donor 334 as to the identifies of its donation recipients, thereby avoiding circumstances which force a merchant, by virtue of its prior commitment, to make a donation to a local community affinity entity whose role, or purpose is inimical or otherwise repugnant to the Merchant-Donor 334. As such, the donation mechanism leaves the direction of the donations fully within the discretion of the customers, limited only by the restriction that the customer can only select from among those affinity entities that serve the local community that is in common to both the customer and the Merchant-Donor 334, while leaving the actual amount of the donation fully within the discretion of the Merchant-Donor 334.

Referring now to FIG. 6, by way of explanation for the nomenclature of reference numerals used and described in the specification, a lower case letter in parenthesis is intended to mean an integer variable having a value from 1 to the capital case of the lower case letter, which value can be large (i.e., approaching infinity). Thus ‘(b)’ is intended to mean that the integer ‘b’ can have a value from 1 to B, and ‘(c)’ is intended to mean that the integer ‘c’ can have a value from 1 to C, etc. As such, drawing elements 408, 410, 478-490 and 496 in FIG. 6 are illustrated with a block, but indicate one or more elements can be present. For example, Affinity Entity (k) 496 is one of a possible plurality of affinity entities, where k may range from 1 to a large integer. Affinity system 60 may be associated with one or more affinity entities.

The diagram of FIG. 6 depicts an exemplary process 400 of a particular financial transaction system in which an account holder (p) 408 conducts a financial transaction with a merchant (m) 410 for which a cash payment is made, where the account holder (p) 408's financial transaction with the merchant (m) 410 may have been incentivized by the merchant (m) 410's agreement to make a donation to an affinity entity in their shared local community as defined by the merchant (m) 410. The data regarding the transaction may be transmitted from merchant system 40 to data storage device 50 for access by loyalty system 20, or from merchant system 40 to loyalty system 20 for subsequent storage at data storage device 50. The data scrub utility 36 may normalize and pre-process merchant data prior to storage at data storage device 50 for example.

Account holder (p) 408 presents cash to a Merchant (m) 410 as tender for a financial transaction such as a purchase of goods and services. Those of skill in the art will recognize that cash equivalents may also be used, including, but not limited to, money in the physical form of currency of at least one of banknotes and coins, a payment on a limited-purpose private-label credit account issued by the merchant to the account holder for use only in transactions with the merchant, a payment on a limited-purpose private-label debit account issued by the merchant to the account holder for use only in transactions with the merchant, a check drawing on an account having funds on deposit and issued by a bank, a cashier's check, a cashier's cheque, a banker's cheque, a bank cheque, an official cheque, a demand draft, a teller's cheque, a bank draft, a treasurer's cheque, a check guaranteed by a bank, a certified check, a check for which a bank verifies that sufficient funds exist in an account upon which the check is drawn to cover the check which is so verified at the time the check is written, a money order, a payment order for a pre-specified amount of money where funds of the payment are prepaid for the amount shown on the payment order, a traveler's cheque, a preprinted, fixed-amount cheque formatted to allow a signature on the cheque in order to make an unconditional payment to the merchant as a result of having paid an issuer of the cheque for the privilege of using the cheque, a closed loop system payment, or a payment on a non-acquired account developed in the future. Of course, a combination of the foregoing could also be used for make the payment for the transaction.

As part of the transaction, the Account Holder (p) 408 can offer a physical or virtual token (at customer device 48) bearing an identifier with which the Account Holder (p) 408 is associated. The token can be a school or government identification card, social security number card, driver's license, credit card, debit card, prepaid card, cellular telephone number, machine readable code, magnetic strip, electronic utility, etc. The token can be read by an electronic reader operated by the Merchant (m) 410 (and coupled to merchant system 40), which as a reader associated with a Point of Service terminal (POS). For example, the reader might read the identifier for the Account Holder (p) 408 from a magnetic strip on a plastic card, a rendering on a display screen of a cellular telephone or Personal Digital Assistant (PDA), a Near Field Communication (NFC) transmission for a card (e.g., a Visa Pay Wave® card) or from smart phone, or other use customer device 48 or a physical object such as a card, etc.

Also shown in FIG. 6 are one or more affinity entities (k) 496 and a Donation Audit Web Service 494 that implementations processes by which donations to the one or more affinity entities (k) 496 from various donors, for instance, the Merchant (m) 410 and the Account Holder (p). The Donation Audit Web Service 494 has access to information resources within the following databases (at data storage device 50, or at another data storage device coupled to loyalty system 20): one or more Account Holder Databases (f) 478, where ‘(f)’ is an integer from 1 to ‘F’, that stores information about each Account Holder (p) 408, one or more Merchant Databases (b) 480, where ‘(b)’ is an integer from 1 to ‘B’, that stores information about each Merchant (m) 410, one or more Transaction Databases 482, where ‘(a)’ is an integer from 1 to ‘A’, that stores information about transactions between each Merchant (m) 410 and each Account holder (p) 408, and one or more Geographic Databases (c) 484, where ‘(c)’ is an integer from 1 to ‘C’, that stores information about local communities with which the Account Holders 408 and the Merchants 410 and the Affinity Entities 496 can be associated through any of several different associations. By way of example, and not by way of limitation, construction of such associations can include factors such as geographic, political, demographics, local transportation modes, navigational algorithms for geopolitical regions, cartographic data, planned communities, population density, cultural divides, racial population constituencies, census statistics, socio-economic factors, and combinations thereof. Donation Audit Web Service 494 may be part of loyalty system 20 or coupled thereto. One or more components of the loyalty system 20 may be used to implement Donation Audit Web Service 494, although shown in FIGS. 2 and 3 to be separate components.

Also seen in FIG. 6 are one or more Affinity Entity Databases 490 (at data storage device 50 or otherwise couple to loyalty system 20 or affinity system 60), where ‘(i)’ is an integer from 1 to ‘I’, to store information about each Affinity Entity (k) 496, one or more Affinity Entity Donations Payable Databases 486, where ‘(d)’ is an integer from 1 to ‘D’, to store information about currency amounts of donations that are obligations that are to be paid by specific donors to each Affinity Entity (k) 496, and one or more Affinity Entity Donations Paid Databases 486, where ‘(d)’ is an integer from 1 to ‘D’, to store information about currency amounts of donations that have been made by donors to each Affinity Entity (k) 496.

Databases 478-490 can be connected by one or more private or public networks, virtual private networks, the Internet, or by other means known to those skilled in the art. Moreover, not every entity seen in FIG. 6 at reference numerals 408, 410, 496 and 494 must necessarily have real time, uninterrupted access to any or all of the Databases 478-490. Each such Databases 478-490 can assign, read, write, and query permissions as appropriate to the various entities. For example, a Merchant (m) 410 may have read access to the Transactions Database (a) 482.

Each of the one or more Transactions Databases (a) 482 can be used to store some or all of the transaction data originating at the Merchants (n) 410 for each cash transaction conducted between an Account holder (p) 408 and the Merchant (m) 410. The transaction data can include information associated with an identifier for the Account holder (p) 408 and the date and time of the transaction, among other more specific information including the amount of the cash transaction. The database can be searched using identifiers for the Account holder (p) 408 and the Merchant (m) 410, date and time (or within proximity thereof), or by any other field stored in the database.

The Transactions Database (a) 482 is also designed to store information about each Merchant (m) 410, where the information can include a unique identification of each Merchant (m) 410, an identifier for each point of sale device in use by the Merchant (m) 410, and a physical geographic location of each store of the Merchant (m) 410.

Also included in the Transactions Database (a) 482 is an identifier for Account holder (p) 408, such as name of an account holder who is registered to participate in a system in which donations can be made to each Affinity Entity (k) 496 as per rules stored in at least one of the Account Holder DB (f) 478 and Merchant DB (b) 480. After registering to participate in the donation system, an Account holder (p) 408 initiates a qualifying purchase transaction with a Merchant (m) 410 by presenting a token bearing an identifier for the Account Holder (p) 408 to the Merchant (m) 410. The token can be also include an offer from the Merchant (m) 410 to the Account Holder (p) 408, where the offer has an expiration against which the time of the transaction can be compared to determine the validity of the offer. The token can be presented at the Point Of Service terminal (POS) that is capable of reading data on the token. Certain transaction information is transmitted from the POS in route to the Donation Audit Web Service 494. The transaction information can include a transaction time stamp, respective merchant, account holder, and offer identifiers, as well as indicia that payment for the transaction was made on an non-acquired account.

The above noted databases may include data relating to benefit accounts 52, merchant accounts 54, member accounts 56, transaction data 58 and other data at data storage device 50. Different databases may provide different logical views of the physical data stored at data storage device 50.

The Donation Audit Web Service 494 uses the respective merchant and account holder identifiers to access and retrieve respective merchant and account holder geographic locations from one or more of the Geographic Databases 484. For each transaction, determinations are made, using the respective merchant and account holder geographic locations, whether the Merchant (m) 410 and the Account Holder (p) 408 have a local community in common, and whether the transaction is being conducted within a predetermined time period using the time of the transaction time stamp and the offer identifier. Note that the expiry of the offer can be retrieved from one or more of the Merchant DB 480 which contains offers and their corresponding offer identifiers assessable to the Donation Audit Web Service 494.

For each said transaction for which the transaction is conducted within the predetermined time period after which the offer will expire and where the Merchant (m) 410 and the Account Holder (p) 408 have a local community in common, the Donation Audit Web Service 494 retrieves a merchant donation business rule for the Merchant (m) 410. Note that the merchant donation business rule can be retrieved from one or more of the Merchant DBs 480 which contains merchant business rules and their corresponding merchant identifiers assessable to the Donation Audit Web Service 494.

From the foregoing, a determination may be made by the Donation Audit Web Service 494 that the Merchant (m) 410 is to make a donation to Affinity Entity (k) 496 which has been determined to have the same local community as that of the Account Holder (p) and Merchant (m) 410. Note that the Affinity Entity (k) 496 can be retrieved from one or more of the Affinity Entity DBs 490 which contains information about Affinity Entity (k) 496 indexed by its corresponding affinity entity identifier assessable to the Donation Audit Web Service 494.

The donation to be made by the Merchant (m) to the Affinity Entity (k) 496 may be derived from Merchant (m) 410 using the merchant donation business rule retrieved from one or more of Merchant DBs 480. Donation Audit Web Service 44 transmits a message containing the donation to be made by the Merchant (m) to the Affinity Entity (k) 496 for the predetermined time period to one or more logical addresses, including a logical address of the Merchant (m) 410, a logical address of the Account Holder (p) 408, and a logical address of the Affinity Entity (k) 496. It is advantageous to send the donation to the logical address of the Account Holder (p) 408 to inform the same of the Merchant (m) 410's commitment to donate. It is advantageous to send the donation to the logical address of the Affinity Entity (k) 496 to inform the same of the Merchant (m) 410's commitment to donate. Alternatively, for reasons stated herein, while it is advantageous to send the amount of the donation to the logical address of the Merchant (m) 410 to inform the same of its commitment to donate, it might not be advantageous to send the identity of the donee to the donor who may object to the donation on the basis of the donee's identity. Accordingly, message sent to the logical address of the Merchant (m) 410 need not identify the donee, and can instead simply send the amount of the donation to the logical address of the Merchant (m) 410.

After a predetermined audit time period for each offer's predetermined time, for each of the merchant identifiers to which transactions pertain as described above, for each Affinity Entity (K) 496 to whom a donation was to be made by the Merchant (m) 410 for the predetermined time period—either directly or through a blind donation distribution service as discussed elsewhere herein, the Donation Audit Web Service 494 determiners a difference between the sum of the currency amounts of the donation receipts that were transmitted to the logical address of the Merchant (m) 410 for the Affinity Entity (K) 496 and the sum of the currency amounts of the donation receipts that were received for the Affinity Entity (K) 496 for the Merchant (m) 410 for the predetermined time period. Any such difference can then be transmitted to a logical address that is one or more of the logical address of the merchant (e.g. at merchant system 40), the logical address of the account holder (e.g. at customer device 48), and the logical address of the affinity entity (e.g. at affinity system 60). It is advantageous to send confirmation of the sum of its donations to the logical address of the Merchant (m) 410 to confirm compliance with its prior commitments to donate. It is advantageous to send a summary of donations made by merchants with whom the Account Holder (p) 408 has paid in cash in order to confirm to the Account Holder (p) 408 the community advantages of doing business with community merchants, where such a summary of merchant donations can be sent to the logical address of the Account Holder (p) 408, thereby informing the same of the integrity of the community merchant's commitment to donate to the community. It is advantageous to send the donation to the logical address of the Affinity Entity (k) 496 to inform the same as to the competition, or absence of completion, as to obligations made by community merchants regarding their respective commitments to donate to the local community of the Merchant (m) 410 and Account Holder (p) 408.

A computed and unacceptably high difference that is sent to the logical address of the Merchant (m) 410 can be used the Merchant (m) 410 to make up the difference by a payment made by the Merchant (m) 410 directly to the Affinity Entity (k) 496 owed. Alternatively, the difference payment can be made indirectly to a blind donations disbursement agency for subsequent payment of the difference to the Affinity Entity (k) 496 to whom the Merchant (m) 410 made a commitment, albeit a blind commitment, to contribute.

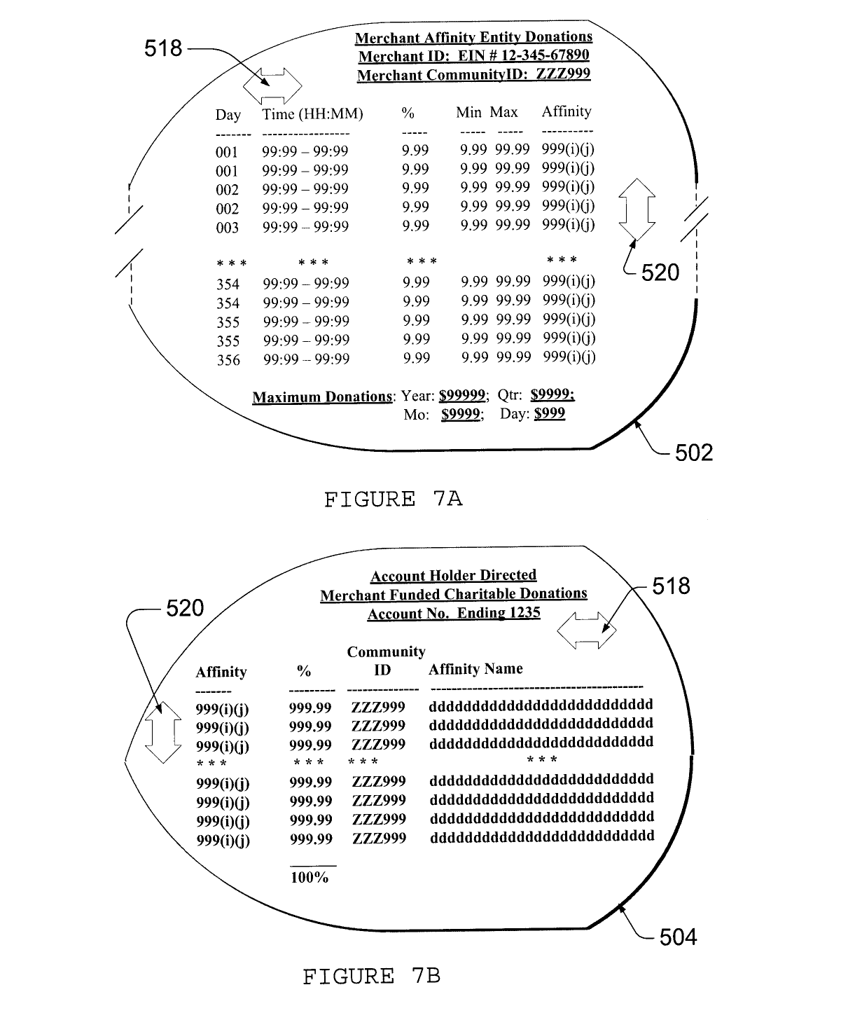

Referring now to FIG. 7a, a screen shot 502 features input and displays fields by which a Merchant (m) 410, or agent thereof, can input terms and conditions under which the Merchant (m) 410 is willing to become legally bound to make a donation to an Affinity Entity (k) 496. The screen shot may be generated by merchant interface 28 and merchant reporting tool 46. Each row in screen shot 502 represent all or a portion of twenty-four (24) hour day of the 356 calendar days of one (1) year. Columns in each row of the table seen in screen shot 502 are, from left to right, as follows: 1st: the numerical calendar day of the year; 2nd-3rd: the hyphenated starting and ending of a time period within the calendar day; 4th: a percentage of a currency amount of any one (1) transaction that the Merchant (m) 410 will commit to make to an Affinity Entity (k) 496; 5th: the minimum currency amount of the transaction before the commitment by the Merchant (m) 410 to make the donation will arise; 6th: the maximum amount of donation that the Merchant (m) 410 is willing to make for any one (1) transaction; and 7th: an identifier for the Affinity Entity (k) 496 to whom the Merchant (m) 410 is to make the donation as described in the row.

The bottom of screen shot 502 allows specification inputs for the Merchant (m) 410 as to its maximum donation across all Affinity Entities 496 for any one day, month, quarter of a year, or year.

By way of example, and not by way of limitation, the data input by the Merchant (m) 410, or agent thereof, at merchant system 40 for display on screen shot 502 can be stored in one or more of the Merchant DBs 480 or other location logically accessible (e.g. merchant accounts 54), via one or more networks or otherwise, to Donation Audit Web Service 494 (at loyalty system 20). These data can also be automatically pre-loaded for Merchant (m) 410 via an automatic initiating service that allows the Merchant (m) 410 to be entered as a participant in a local community charitable donations program through traffic each store location of the Merchant (m) 410 in the local community will be incentivized to increase.

Referring now to FIG. 7b, a screen shot 504 features input and displays fields by which an Account Holder (p) 408, or agent thereof, can direct a third party donor, such as a Merchant (m) 410 with whom the Account Holder (p) 408 is conducting a transaction for a cash payment, to become legally bound to make a donation to an Affinity Entity (k) 496. The fields provided by screen shot 502 allow the customer to specify one or more affinity entities in their local community to which donations are to be made by merchants with whom the customer conducts cash transactions. In such implementations, each merchant is given notice of its total periodic donations. Such notice, however, can optionally be given without providing the merchant with any notice or knowledge as to the specific identity of those affinity entities that are to be the recipients of its donations. The donation mechanism can be set up such that the merchant makes blind donations, either directly or indirectly, to affinity entities in the local community of both the merchant and its customer who selects those local community affinity entities. Accordingly, the donation mechanism can leave direction of merchant's donations fully within the discretion of the merchant's customers, limited only by the restriction that the customer can only select from among those affinity entities that serve the local community that is in common to both the merchant and the customer, while leaving the actual amount of the merchant's donation fully within the discretion of the merchant as shown in FIG. 7a.

Optionally, a further limitation on those local community affinity entities that can be selected by the customer can include an algorithm deriving a rating for an affinity entity, where the algorithm uses one or more ratings given by one or more charity rating organizations, where the algorithm's result is used to determine whether or not the affinity entity is eligible for participation in the implementation as a registered affinity entity that is selectable by local community customers. Example of charity rating organizations which provide one or more ratings that could be used for various disclosed implementations include Guide Star, Charity Navigator, Give Well, Evangelical Council for Financial Accountability (ECFA), the Better Business Bureau Wise Giving Alliance Standards for Charity Accountability of the Council of Better Business Bureaus, Inc., and the like.

Each row in screen shot 504 of FIG. 7b represents a different Affinity Entity (k) 496 in the local community of the customer for which there is a specific code (e.g., 999(i)(j), Community Identifier (e.g., ZZZ999), and Affinity Name as shown in FIG. 7b. A pull down menu of selectable affinity entities (not shown) can be used to provide selectable input to the fields corresponding to affinity entities shown on screen shot 504.

By way of example, the Affinity Entity and/or the Community ID might identify a specific Affinity Entity (k) 496 that is located in, and provide goods and services to, the borough of Greenwich Village at the southern portion of the geographical island of Manhattan in the city of New York of the State of New York, in the USA. By way of example, and not by way of limitation, the Affinity Entity Code 105(064) (q2e) could have an interpretation where ‘105’ represents the United States of America, the index ‘064’ represents the state of New York, “q” represents the City of New York, “2” represents the combined boroughs of Manhattan, and “e” represents the borough of Greenwich Village at the southern portion of the geographical island of Manhattan in the city of New York of the State of New York. The name of the specific Affinity Entity (k) 496 represented the code 105(064) (q2e) can be the Washington Square Food Bank, which may be located in, and provide goods and services to, the borough of Greenwich Village at the southern portion of the geographical island of Manhattan in the city of New York of the State of New York, in the USA. Note that the Account Holder (p) 408 can use screen shot 502 to specify multiple community IDs each representing a geographic location where the Account Holder (p) 408 either has a residence or operates a business in the geographic location. Also note that, for each such community ID specified by the Account Holder (p) 408, the second column of the rows of screen shot 504 in FIG. 7b will preferably add up to 100%, thereby provide a percentage the donation made by the Merchant (m) 410 with whom the Account Holder (p) 408 conducting a transaction for a cash payment.

For screen shots 502-504, input and selection of data for each charity can be via a typical user experience including but not limited to keyboard data entry, pull down menus, pictograph optical scanning with a cellular telephony device as read from print or electronic media rendering, etc. Horizontal 518 and vertical 520 panning can be user activated to move that portion of the display being rendered horizontally and vertically, respectively.

The Account Holder (p) 408 and the Merchant (m) 410 can change or disable a donation commitment at any time by accessing a server that serves web pages rendering screen shots 502, 504, respectively. Thus, charitable donation commitments can be easily and instantly enabled or disabled using the real time user interface. By way of example, and not by way of limitation, such servers can be hosted by the Donation Audit Web Service 494 seen in FIG. 6.

Referring again now to FIGS. 1, 2, 3, 6, further illustrations are seen of a telecommunications network that may make use of any suitable telecommunications network and may involve different hardware, different software and/or different protocols then those discussed below. FIGS. 1, 2, 3, 6 may use a global telecommunications network that supports purchase and cash transactions using any bankcard, travel and entertainment cards, and other private label and proprietary cards. The network also supports ATM transactions for other networks, transactions using paper checks, transactions using smart cards and transactions using other financial instruments. These transactions are processed through the network's authorization, clearing and settlement services. Authorization occurs when an issuer approves or declines a sales transaction before a purchase is finalized or cash is dispersed. Clearing occurs when a transaction is delivered from an acquirer to an issuer for posting to the customer's account. Settlement is the process of calculating and determining the net financial position of each member for all transactions that are cleared. The actual exchange of funds is a separate process.

In at least some implementations, the system may include one or more processors (e.g., digital signal processors, microprocessors, etc.), each being adapted to execute instructions to perform at least some of the methods, operations, and processes described herein with respect to the figures. Such instructions may be stored or held in storage media as instructions.

The methodologies described herein may be implemented in different ways and with different configurations depending upon the particular application. For example, such methodologies may be implemented in hardware, firmware, and/or combinations thereof, along with software. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

The herein described storage media may comprise primary, secondary, and/or tertiary storage media. Primary storage media may include memory such as random access memory and/or read-only memory, for example. Secondary storage media may include a mass storage such as a magnetic or solid-state hard drive. Tertiary storage media may include removable storage media such as a magnetic or optical disk, a magnetic tape, a solid-state storage device, etc. In certain implementations, the storage media or portions thereof may be operatively receptive of, or otherwise configurable to couple to, other components of a computing platform, such as a processor.

In at least some implementations, one or more portions of the herein described storage media may store signals representative of data and/or information as expressed by a particular state of the storage media. For example, an electronic signal representative of data and/or information may be “stored” in a portion of the storage media (e.g., memory) by affecting or changing the state of such portions of the storage media to represent data and/or information as binary information (e.g., ones and zeros). As such, in a particular implementation, such a change of state of the portion of the storage media to store a signal representative of data and/or information constitutes a transformation of storage media to a different state or thing.

Some portions of the preceding detailed description have been presented in terms of algorithms or symbolic representations of operations on binary digital electronic signals stored within a memory of a specific apparatus or special purpose computing device or platform. In the context of this particular specification, the term specific apparatus or the like includes a general-purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels.

Unless specifically stated otherwise, as apparent from the following discussion, it is appreciated that throughout this specification discussions utilizing terms such as “processing,” “computing,” “calculating,”, “identifying”, “determining”, “establishing”, “obtaining”, and/or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. In the context of this particular patent application, the term “specific apparatus” may include a general-purpose computer once it is programmed to perform particular functions pursuant to instructions from program software.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in some implementations” or other like phrases in various places throughout this specification are not necessarily all referring to the same feature, example, and/or limitation. Furthermore, the particular features, structures, or characteristics may be combined in one or more examples and/or features.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of appended claims, and equivalents thereof.

The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes. Based on the disclosure and teachings provided herein, a person of ordinary skill in the art will appreciate other ways and/or methods for various implements. Moreover, it is understood that a functional step of described methods or processes, and combinations thereof can be implemented by computer program instructions that, when executed by a processor, create means for implementing the functional steps. The instructions may be included in non-transitory computer readable medium that can be loaded onto a general-purpose computer, a special purpose computer, or other programmable apparatus.

In the preceding detailed description, numerous specific details have been set forth to provide a thorough understanding of claimed subject matter. However, it will be understood by those skilled in the art that claimed subject matter may be practiced without these specific details. In other instances, methods and systems that would be known by one of ordinary skill have not been described in detail so as not to obscure claimed subject matter.

1. An incentive method for a plurality of merchant systems conducting transactions with account holders, the method comprising a plurality of steps each being performed by hardware executing software, wherein the steps include:
receiving, at a processor, for each said transaction:
a transaction time stamp;
respective merchant, account holder, and offer identifiers; and
indicia that payment for the transaction was made on a non-acquired account;
retrieving, from a persistent store, using the respective merchant and account holder identifiers, respective merchant and account holder geographic locations;
for each said transaction:
determining, at the processor, using the respective merchant and account holder geographic locations, whether the merchant and the account holder have a geographical location in common; and
determining, at the processor, whether the transaction is being conducted within a predetermined time period using:
the transaction time stamp; and
the offer identifier;
for each said transaction for which:
the transaction is conducted within the predetermined time period; and
the merchant and the account holder have a geographical location in common:
retrieving, using the merchant identifier, a merchant donation business rule for the merchant to make a donation to an affinity entity having:
a geographical location in common with that of the respective merchant and account holder geographic locations; and
an affinity entity identifier;
deriving a donation to be made by the merchant to the affinity entity for the predetermined time period using the merchant donation business rule;
transmitting a message containing the donation to be made by the merchant to the affinity entity for the predetermined time period to a logical address selected from the group consisting of:
a logical address of the merchant;
a logical address of the account holder;
a logical address of the affinity entity; and
a combination thereof;
and
within a predetermined audit time period for the predetermined time period:
receiving a plurality of donation receipts each including:
the respective merchant and affinity entity identifiers;
and a currency amount;
and
for each said identifier for the merchant, deriving the sum of the currency amounts of the donation receipts for each said affinity entity identifier.

2. The method as defined in claim 1, wherein the steps further comprise, after the predetermined audit time period for the predetermined time, for each said merchant identifier:
for each said affinity entity to whom a donation was to be made by the merchant for the predetermined time period:
determining a difference between:
the sum of the currency amounts of the donation receipts that were transmitted to the logical address of the merchant for the affinity entity; and
the sum of the currency amounts of the donation receipts that were received for the affinity entity for the merchant for the predetermined time period;
and
transmitting the determined difference to a logical address selected from the group consisting of:
the logical address of the merchant;
the logical address of the account holder;
the logical address of the affinity entity; and
a combination thereof.

3. The method as defined in claim 1, wherein each said payment for each said transaction made on each said non-acquired account is a payment type selected from the group consisting of:
cash;
money in the physical form of currency of at least one of banknotes and coins;
a payment on a limited-purpose private-label credit account issued by the merchant to the account holder for use only in transactions with the merchant;
a payment on a limited-purpose private-label debit account issued by the merchant to the account holder for use only in transactions with the merchant;
a check drawing on an account having funds on deposit and issued by a bank;
a cashier's cheque;
a banker's cheque;
a bank cheque;
an official cheque;
a demand draft;
a tellers cheque;
a bank draft;
a treasurers cheque;
a check guaranteed by a bank;
a certified check;
a check for which a bank verifies that sufficient funds exist in an account upon which the check is drawn to cover the check which is so verified at the time the check is written;
a money order;
a payment order for a pre-specified amount of money where funds of the payment are prepaid for the amount shown on the payment order;
a travelers cheque;
a preprinted, fixed-amount cheque formatted to allow the account holder to sign the cheque in order to make an unconditional payment to the merchant as a result of having paid an issuer of the cheque for the privilege of using the cheque;
a closed loop system payment;
a payment on a non-acquired account developed in the future; and
a combination thereof.

4. The method as defined in claim 1, wherein the steps further comprise retrieving, using at least one of the respective merchant, account holder, and affinity entity identifiers, a logical address selected from the group consisting of:
the logical address of the merchant;
the logical address of the account holder;
the logical address of the affinity entity; and
a combination thereof.

5. The method as defined in claim 1, wherein:
the receiving step further comprises receiving an account holder voluntary donation currency amount;
and
the transmitted message contains as the donation to be made by the merchant to the affinity entity for the predetermined time period the sum of:
the account holder voluntary donation currency amount; and
the derived said donation to be made by the merchant to the affinity entity for the predetermined time period.

6. The method as defined in claim 1, wherein:
the receiving step further comprises receiving a currency amount for the transaction;
and
the merchant donation business rule for making a donation is a function, at least in part, of the received currency amount.

7. A non-transient computer readable medium comprising software executed by hardware to perform the steps of the method as defined in claim 1.

8. An incentive method for a plurality of merchants conducting transactions with account holders, the method comprising a plurality of steps each being performed by hardware executing software, wherein the steps include:
receiving, at a processor, for each said transaction:
a transaction time stamp;
respective merchant, account holder, and offer identifiers; and
indicia that payment for the transaction was made on a non-acquired account;
retrieving, at a persistent store, using the respective merchant and account holder identifiers, respective merchant and account holder geographic locations;
for each said transaction:
determining, at the processor, using the respective merchant and account holder geographic locations, whether the merchant and the account holder have a geographical location in common; and
determining whether the transaction is being conducted within a predetermined time period using:
the transaction time stamp; and
the offer identifier;
for each said transaction for which:
the transaction is conducted within the predetermined time period; and
the merchant and the account holder have a geographical location in common:
retrieving, at the persistent store, using the account holder identifier:
an account holder donation business rule for the merchant to make a donation to an affinity entity having:
a geographical location in common with that of the respective merchant and account holder geographic locations;
and
an affinity entity identifier;
retrieving, using the merchant identifier, a merchant donation business rule;
deriving, at the processor, a donation to be made by the merchant to the affinity entity for the predetermined time period using the respective account holder and merchant donation business rules;
transmitting a message containing the donation to be made by the merchant to the affinity entity for the predetermined time period to a logical address selected from the group consisting of:
a logical address of the merchant;
a logical address of the account holder;
a logical address of the affinity entity; and
a combination thereof;
and
within a predetermined audit time period for the predetermined time period:
receiving a plurality of donation receipts each including:
the respective merchant and affinity entity identifiers; and
a currency amount;
and
for each said identifier for the merchant, deriving the sum of the currency amounts of the donation receipts for each said affinity entity identifier.

9. The method as defined in claim 8, wherein the steps further comprise, after the predetermined audit time period for the predetermined time, for each said merchant identifier:
for each said affinity entity to whom a donation was to be made by the merchant for the predetermined time period:
determining a difference between:
the sum of the currency amounts of the donation receipts that were transmitted to the logical address of the merchant for the affinity entity; and
the sum of the currency amounts of the donation receipts that were received for the affinity entity for the merchant for the predetermined time period;
and
transmitting the determined difference to a logical address selected from the group consisting of:
the logical address of the merchant;
the logical address of the account holder;
the logical address of the affinity entity; and
a combination thereof.

10. The method as defined in claim 8, wherein each said payment for each said transaction made on each said non-acquired account is a payment type selected from the group consisting of:
cash;
money in the physical form of currency of at least one of banknotes and coins;
a payment on a limited-purpose private-label credit account issued by the merchant to the account holder for use only in transactions with the merchant;
a payment on a limited-purpose private-label debit account issued by the merchant to the account holder for use only in transactions with the merchant;
a check drawing on an account having funds on deposit and issued by a bank;
a cashier's cheque;
a banker's cheque;
a bank cheque;
an official cheque;
a demand draft;
a tellers cheque;
a bank draft;
a treasurers cheque;
a check guaranteed by a bank;
a certified check;
a check for which a bank verifies that sufficient funds exist in an account upon which the check is drawn to cover the check which is so verified at the time the check is written; a money order;
a payment order for a pre-specified amount of money where funds of the payment are prepaid for the amount shown on the payment order;
a travelers cheque;
a preprinted, fixed-amount cheque formatted to allow a signature on the cheque in order to make an unconditional payment to the merchant as a result of having paid an issuer of the cheque for the privilege of using the cheque;
a closed loop system payment;
a payment on a non-acquired account developed in the future; and
a combination thereof.

11. The method as defined in claim 8, wherein the steps further comprise retrieving, using at least one of the respective merchant, account holder, and affinity entity identifiers, a logical address selected from the group consisting of:
the logical address of the merchant;
the logical address of the account holder;
the logical address of the affinity entity; and
a combination thereof.

12. The method as defined in claim 8, wherein:
the receiving step further comprises receiving an account holder voluntary donation currency amount;
and
the transmitted message contains as the donation to be made by the merchant to the affinity entity for the predetermined time period the sum of:
(i) the account holder voluntary donation currency amount; and
(ii) the derived said donation to be made by the merchant to the affinity entity for the predetermined time period.

13. The method as defined in claim 8, wherein:
the receiving step further comprises receiving a currency amount for the transaction;
and
the derivation of the donation to be made by the merchant to the affinity entity for the predetermined time period using the respective account holder and merchant donation business rules is a function, at least in part, of the received currency amount.

14. A non-transient computer readable medium comprising software executed by hardware to perform the steps of the method as defined in claim 8.

15. A computer hardware server in communication with a network comprising hardware executing software that is operable to:
receive from a client processor in communication with the network:
a transaction time stamp;
respective merchant, account holder, and offer identifiers for a transaction; and
indicia that payment for the transaction was made on a non-acquired account;
access a geographic database in communication with the network to retrieve, using the respective merchant and account holder identifiers, respective merchant and account holder geographic locations;
determine, using the respective merchant and account holder geographic locations, whether the merchant and the account holder have a geographical location in common; and
determine whether the transaction is being conducted within a predetermined time period using:
the transaction time stamp; and
the offer identifier;
access, when the transaction is conducted within the predetermined time period and the merchant and the account holder have a geographical location in common, a donation business rules database in communication with the network to retrieve, using at least one of the respective merchant and account holder identifiers, a donation business rule for the merchant to make a donation to an affinity entity having:
a geographical location in common with that of the merchant and account holder; and
an affinity entity identifier;
derive a donation to be made by the merchant to the affinity entity for the predetermined time period using the donation business rule; and
transmit a message containing the donation to be made by the merchant to the affinity entity for the predetermined time period to a logical address selected from the group consisting of:
a logical address of the merchant;
a logical address of the account holder;
a logical address of the affinity entity; and
a combination thereof.

16. The server as defined in claim 15, wherein the hardware executing the software is further operable to:
within a predetermined audit time period for the predetermined time period:
receive a plurality of donation receipts each including:
the respective merchant and affinity entity identifiers; and
a currency amount;
and
derive, for each said identifier for the merchant, the sum of the currency amounts of the donation receipts for each said affinity entity identifier.

17. The server as defined in claim 16, wherein for a plurality of said transactions, the hardware executing the software is further operable, after the predetermined audit time period for the predetermined time, for each said merchant identifier:
for each said affinity entity to whom a donation was to be made by the merchant for the predetermined time period:
to determine a difference between:
the sum of the currency amounts of the donation receipts that were transmitted to the logical address of the merchant for the affinity entity; and
the sum of the currency amounts of the donation receipts that were received for the affinity entity for the merchant for the predetermined time period;
and
to transmit the determined difference to a logical address selected from the group consisting of:
the logical address of the merchant;
the logical address of the account holder;
the logical address of the affinity entity; and
a combination thereof.

18. The server as defined in claim 15, wherein the payment for each said transaction made on each said non-acquired account is a payment type selected from the group consisting of:
cash;
money in the physical form of currency of at least one of banknotes and coins;
a payment on a limited-purpose private-label credit account issued by the merchant to the account holder for use only in transactions with the merchant;
a payment on a limited-purpose private-label debit account issued by the merchant to the account holder for use only in transactions with the merchant;
a check drawing on an account having funds on deposit and issued by a bank;
a cashier's cheque;
a banker's cheque;
a bank cheque;
an official cheque;
a demand draft;
a teller's cheque;
a bank draft;
a treasurer's cheque;
a check guaranteed by a bank;
a certified check;
a check for which a bank verifies that sufficient funds exist in an account upon which the check is drawn to cover the check which is so verified at the time the check is written;
a money order;
a payment order for a pre-specified amount of money where funds of the payment are prepaid for the amount shown on the payment order;
a traveler's cheque;
a preprinted, fixed-amount cheque formatted to allow a signature on the cheque in order to make an unconditional payment to the merchant as a result of having paid an issuer of the cheque for the privilege of using the cheque;
a closed loop system payment;
a payment on a non-acquired account developed in the future; and
a combination thereof.

19. The server as defined in claim 15, wherein the hardware executing the software further operable to access a logical address database to retrieve, using at least one of the respective merchant, account holder, and affinity entity identifiers, a logical address selected from the group consisting of:
the logical address of the merchant;
the logical address of the account holder;
the logical address of the affinity entity; and
a combination thereof.

20. The server as defined in claim 15, wherein:
the receipt from the client in communication with the network further comprises an account holder voluntary donation currency amount;
and
the transmitted message contains as the donation to be made by the merchant to the affinity entity for the predetermined time period the sum of:
the account holder voluntary donation currency amount; and
the derived said donation to be made by the merchant to the affinity entity for the predetermined time period.

21. The server as defined in claim 15, wherein:
the receipt from the client in communication with the network further comprises a currency amount for the transaction; and
the derivation of the donation to be made by the merchant to the affinity entity for the predetermined time period using the respective account holder and merchant donation business rules is a function, at least in part, of the received currency amount.
